(19) United States
(12) Patent Application Publication
(10) Pub. No.: US 2008/0158341 A1
(43) Pub. Date: Jul. 3, 2008

(54) CAMERA FOR PANORAMIC PHOTOGRAPHY

(75) Inventors: Tito Gelsomini, Plano, TX (US); Harvey Davis, Trenton, TX (US); Andrew Marshall, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/616,684

(22) Filed: Dec. 27, 2006

(51) Int. Cl. H04N 7/00

(52) U.S. Cl. 348/36; 348/E07.001

(57) ABSTRACT

An angle sensor 302 in a digital or film camera senses the absolute or differential azimuth angle of the camera. At the time of first image capture, the camera azimuth angle H1 is latched in storage register 304. A constant angle value K degrees is added to this stored angle H1, and the sum is then a target angle value H1+K. As the camera continues to rotate, angle value H is compared in comparator 306 to H1+K, and when substantially equal, a command is generated activating shutter 318 to capture the second image and store the current azimuth angle H2 in storage register 304. An alternative embodiment stores a reference image portion pixel data set from a reference image portion 404 of the first captured image. As the camera rotates, a new pixel data set from a sampled image portion on the opposite side of the field of view is captured every few degrees, and is compared to the stored reference image portion pixel data set. When the camera has rotated such that the sampled image portion pixel data set substantially equals the reference image portion pixel data set, a peak in correlation occurs which generates a shutter activation command to capture the next image in the sequence. At the substantially same time a new reference image portion pixel data set is stored.

### BACKGROUND OF THE INVENTION

1. Field Of The Invention

This invention relates generally to photography, and, in particular, to panoramic photography with a digital camera, by capturing multiple overlapping images which may be electronically merged to form a single image.

2. Description Of The Related Art

The lens system of typical film and digital cameras captures images with an aspect ratio (width to height ratio) of approximately 1.5 (3:2). For example, a frame of typical 35 mm film measures 36 mm by 24 mm (3:2 aspect ratio). Most digital cameras use image sensors having a 4:3 aspect ratio, to match the 4:3 aspect ratio of many computer monitors and televisions.

Panoramic photographs generally have an aspect ratio significantly higher than 1.5. One type of panoramic camera uses a wide angle lens to capture a panoramic image on a portion of one standard film frame; for example, an image 36mm wide and 12 mm high (rather than the standard 24 mm high) on a standard frame of 35 mm film, yielding a 3:1 aspect ratio. A digital camera can similarly use a wide-angle lens and a portion of the camera image sensor to capture a high aspect ratio panoramic image. One disadvantage of such an approach is the loss of detail compared to a standard image, since only a fraction of the imager area is utilized.

Some digital cameras have a means of taking multiple images and later combining them, a process sometimes referred to as image stitching. For example, a panoramic picture of a landscape might be captured with two 4:3 images, with the camera being rotated between each image an amount somewhat less than its horizontal field of view. Each image therefore has some overlap with the adjacent image. After downloading these images to a computer, special software may be used to position the images and remove redundant pixels in the overlap areas, resulting in a final panoramic image having nearly twice the aspect ratio of the standard image. This panoramic image has significantly higher resolution than one captured using a portion of the image sensor, since each of the two images has nearly the full resolution of the image sensor (reduced by the amount of overlap). Assuming a standard digital camera with 4:3 image sensor, and negligible overlap between images, an 8:3 panoramic image captured with two standard 4:3 images will have nearly four times the resolution of an 8:3 panoramic image captured using half of one 4:3 image. This increased resolution is especially valuable if the native resolution of the camera is limited, as is the case with many cell phone cameras.

Some digital cameras have a means of displaying the edge of a previous image at the left or right edge of the electronic viewfinder, to aid the photographer in properly rotating and positioning the camera for the next image. While such electronic assistance enables more precise stitching of the resulting images later, the photographer still must manually activate the shutter for each image, slowing the overall capture of multiple images.

### SUMMARY OF THE INVENTION

The invention provides an apparatus and method for simplifying the capture of a panoramic image comprising multiple standard images, by electronically activating the shutter for each of multiple images as the camera is rotated in a horizontal or vertical manner.

In an embodiment of the invention described in greater detail below, an azimuth sensor such as an electronic compass or turn rate sensor is used to measure the horizontal pointing angle, or change in pointing angle, of the camera. The shutter is then activated each H degrees of change in pointing angle, where H is typically somewhat less than the horizontal angular field of view of the imaging system, thus providing overlap of adjacent images as is desirable for later image stitching.

Another embodiment of the invention, also described in greater detail below, uses an elevation sensor such as a tilt sensor or turn rate sensor to measure the vertical pointing angle of the camera. The shutter is activated each V degrees of change in pointing angle, where V is typically somewhat less than the vertical angular field of view of the imaging system.

Another embodiment of the invention, also described in greater detail below, stores a fraction of image N, typically the left, right, top and/or bottom edges, then measures correlation between, for example, the stored right edge of image N and the left edge of a subsequent series of trial images taken as the camera is rotated. The shutter is then activated to capture image N+1 at the time correlation peaks.

As further described below, the disclosed topology provides a combination of desirable properties not available in the known art, including a simpler way to capture multiple images with suitable overlap to allow accurate stitching of these images into a strip or mosaic having higher resolution and/or panoramic aspect ratio.

Further benefits and advantages will become apparent to those skilled in the art to which the invention relates.

### DESCRIPTION OF THE VIEWS OF THE DRAWINGS

Example embodiments are described below with reference to accompanying drawings, wherein:

FIG. 1 shows a horizontal azimuth angle sensor incorporated into a camera, and its changing measured azimuth angle as the camera is rotated;

FIG. 2 shows a camera having a vertical elevation angle sensor, and its changing measured elevation angle as the camera is tilted;

FIG. 3 is a block diagram of a system which compares the output of a an angle sensor to a reference value incrementing by K degrees each time an image is taken, facilitating automated shutter activation each K degrees of camera rotation; and

FIG. 4 shows pixel values of a stored edge of image N being compared to changing pixels of the opposite edge of the field of view as the camera is rotated, and the resulting peak in correlation which triggers shutter activation to capture image N+1.

Throughout the drawings, like elements are referred to by like numerals.

### DETAILED DESCRIPTION

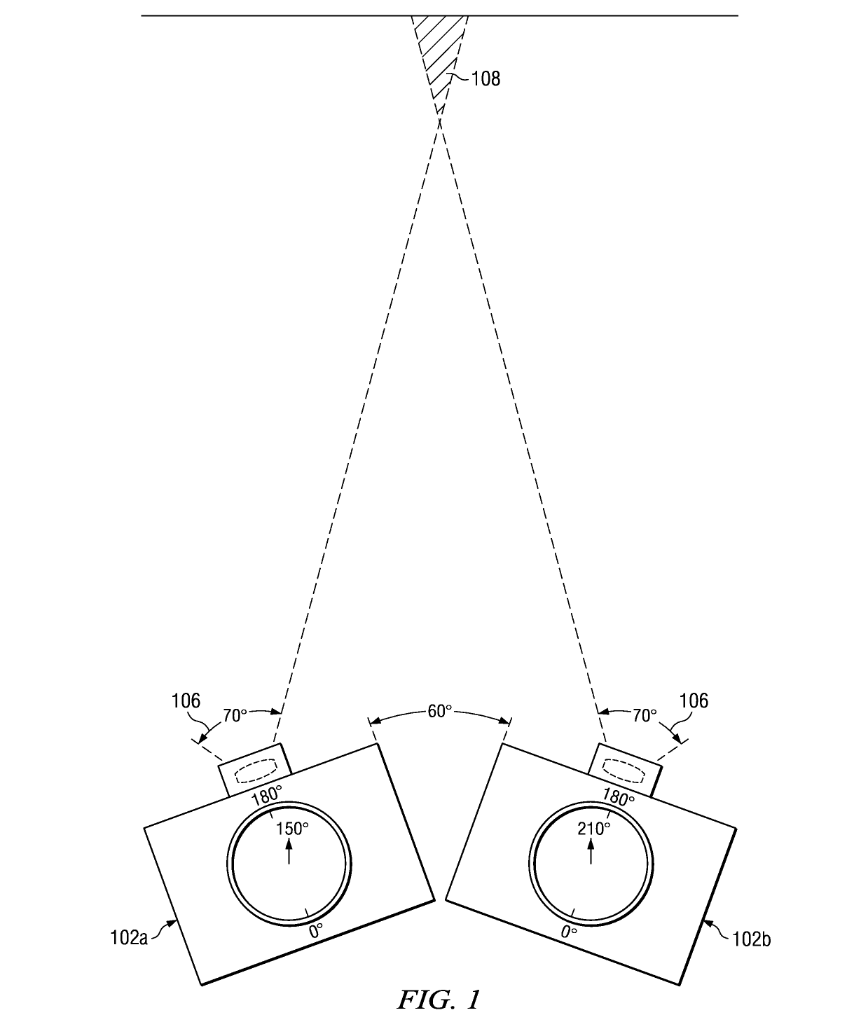

As shown in FIG. 1, camera 102A, representing camera 102 in a first position A, has a first horizontal azimuth angle corresponding to the first of a multiplicity of images to be captured to generate a horizontal panoramic image. Presume, for example, the horizontal field of view 106 of camera 102 is 70 degrees, and further presume that 10 degrees of overlap is desired between adjacent images. Azimuth angle sensor 104 comprises an electronic compass, a differential azimuth angle sensor such as a turn rate sensor, or other known azimuth angle sensor. The azimuth angle value at the time of first image capture is 150 degrees, for example, and is stored as a starting reference. As camera 102 is rotated to azimuth angle as shown in 102B, the azimuth angle value changes to 210 degrees, at which time the shutter is automatically activated, capturing the second or subsequent image which typically overlaps the prior image as shown by overlap 108.

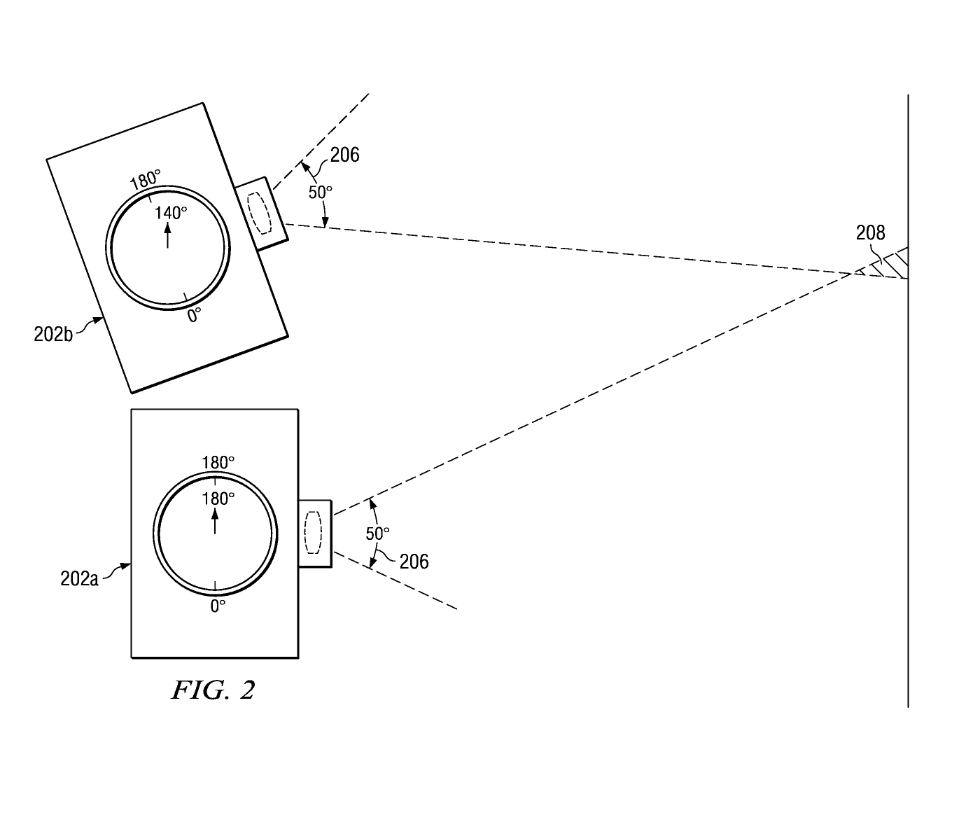

As shown in FIG. 2, camera 202A, representing camera 202 in a first position A, has a first vertical elevation angle corresponding to the first of a multiplicity of images to be captured to generate a vertical panoramic image. Presume, for example, the vertical field of view 206 of camera 202 is 50 degrees, and further presume that 10 degrees of overlap is desired between adjacent images. Elevation angle sensor 204 comprises an electronic tilt sensor, a differential elevation angle sensor such as a turn rate sensor, or other known elevation angle sensors. The elevation angle value at the time of first image capture is 180 degrees, for example, and is stored as a starting reference. As camera 202 is rotated to elevation angle as shown in 202B, the azimuth angle value changes to 140 degrees, at which time the shutter is automatically activated, capturing the second or subsequent image which typically overlaps the prior image as shown by overlap 208.

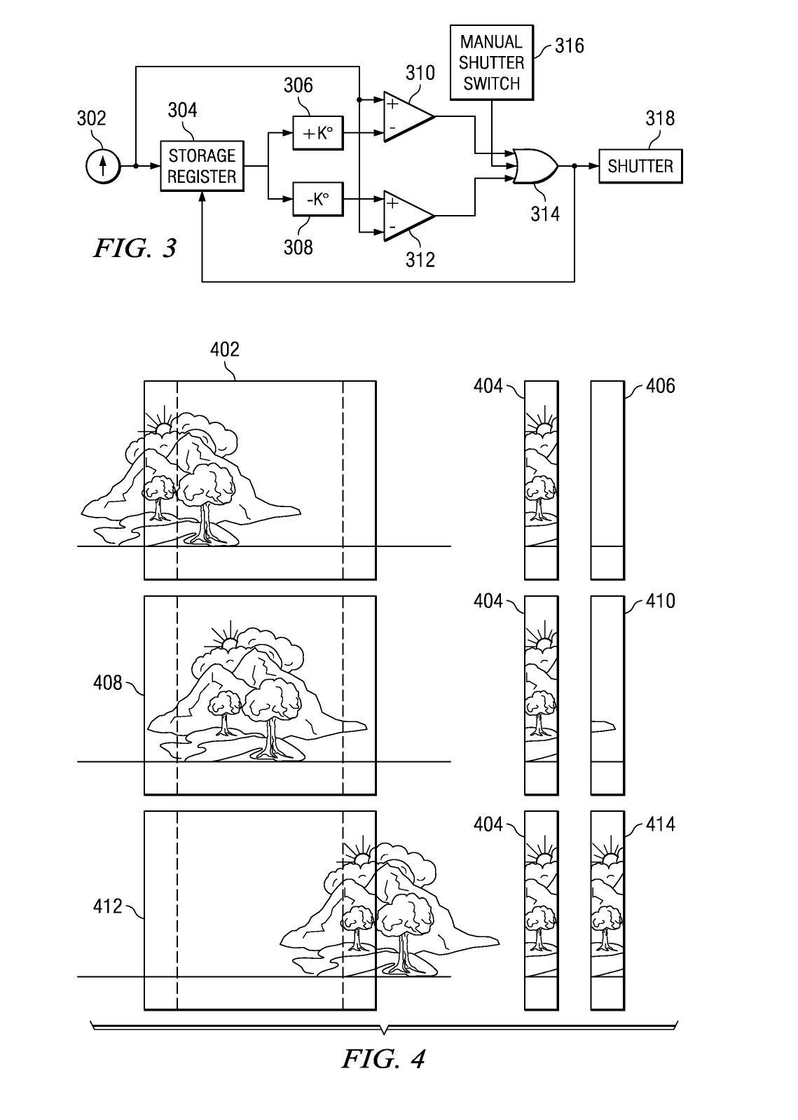

In FIG. 3, angle sensor 302 generates a signal representative of the pointing angle of the camera. This signal may be analog or digital, and may represent horizontal azimuth angle or vertical elevation angle. For this example presume a digital signal in the range of 0 to 360 degrees. Further presume it is desired to generate a shutter-open command every 60 degrees of angular change. At the start of a panoramic capture, manual shutter switch 316 is pressed by the photographer. The pulse from manual shutter switch 316 is coupled to one input of logical OR gate 314. Because the outputs of comparators 310 and 312 are both low at this time, the pulse from manual shutter switch 316 results in a corresponding pulse at the output of logical OR gate 314. The output of logical OR gate 314 is coupled to the latch input of storage register 304 and the activating input of shutter 318. The angle signal output from angle sensor 302 is coupled to the input of register 304. The activation of manual shutter switch 316 thus couples a pulse to shutter 318 and the latch input of storage register 304, causing capture of the first image and storage of the first image angle signal in register 304.

The output of register 304 is coupled to adder 306, which adds a constant value K corresponding to the desired angle between successive images—in this example, 60 degrees. The output of adder 306 is coupled to the inverting input of comparator 310. The non-inverting input of comparator 310 is coupled to the output of angle sensor 302. Presuming the camera is being rotated in such a manner as to increase the angle sensor output, the output of comparator 310 will transition from logical low to high when the camera angle has increased by typically K degrees relative to the first image angle. This pulse is coupled to a second input of logical OR gate 314, and, since all other inputs of logical OR gate 314 are now low, the pulse appears at the output of logical OR gate 314 and is coupled to the shutter 318, causing the second image to be captured. At essentially the same time this output from logical OR gate 314 is coupled to the latch input of register 304, thereby storing the second image angle in storage register 304, in a manner analogous to that previously described. As the camera continues to turn, shutter commands will thus be generated at the output of logical OR gate 314 typically every K degrees of rotation to capture subsequent images.

If it is desired to allow camera rotation in a direction which causes a decrease in azimuth angle, adder 308 and comparator 312 may be utilized. Adder 308 operates similarly to adder 306, but it adds a negative constant −K. The output of adder 308 is coupled to the positive input of comparator 312, while the output of angle sensor 302 is coupled to the negative input of comparator 312. The output of comparator 312 thus transitions from logical low to high each time the camera angle changes by −K degrees. The output of comparator 312 is coupled to a third input of logical OR gate 314 and causes a shutter command each K degrees, in a manner analogous to system operation with the camera rotating in the opposite direction.

In FIG. 4 a reference image portion 404 of first image 402, representing pixel data for the left edge of the field of view, is stored at full or reduced resolution at the time of first image capture. As the camera is rotated, in this example counter-clockwise, the pixel data in sampled image portion 406, 410, 414 of the image at the right edge of the field of view is rapidly and repeatedly sampled. Each subsequent set of sampled right-side pixel data, represented by sampled image portion 406, 410, 414, is compared in turn to the stored reference image portion pixel data. As represented by sampled image 408 and sampled image portion 410, little correlation exists between pixels of reference image portion 404 and sampled image portion 410. However, with the camera in the angular position represented by sampled image 412, strong correlation occurs between reference image portion 404 and sampled image portion 414. This strong correlation signifies that the image content which had been at the left edge of the frame has moved to the right edge of the image frame. At this angle of strong correlation, the shutter is automatically activated to capture the second or subsequent image, and a new left edge pixel data set reference image portion 404 is stored, and the above process repeated if additional captured images are desired. As will be evident to those skilled in the art, the correlation process described above may be accomplished without the need for an angular sensor as used in the embodiments previously described

Those skilled in the art to which the invention relates will appreciate that yet other substitutions and modifications can be made to the described embodiments, without departing from the spirit and scope of the invention as described by the claims below.

What is claimed is:

1. An apparatus for automatically causing a camera to capture a multiplicity of images as it is rotated through an angle, comprising:
angle sensor responsive to the pointing angle of the camera and having as an output a signal representative of the current pointing angle;
angle storage, storing current pointing angle each time the camera captures an image;
angle adder, having as one input most recent stored pointing angle, and having as second input a substantially constant incremental angle, and providing as an output a next pointing angle which is the sum of said most recent stored pointing angle and said incremental angle;
angle comparator having said current pointing angle as first input and said next pointing angle as second input, and generating an image capture command when said first input and said second input are substantially equal.

2. The apparatus as defined in claim 1, wherein said angle sensor comprises a magnetic compass responsive to the magnetic field of the earth.

3. The apparatus as defined in claim 1, wherein said angle sensor comprises a gyroscopic compass.

4. The apparatus as defined in claim 1, wherein said angle sensor comprises a turn rate sensor.

5. The apparatus as defined in claim 1, further comprising a second said angle sensor, second said angle storage, second said angle adder, second said angle comparator so as to be responsive to both horizontal angle (azimuth) and vertical angle (tilt) of said camera.

6. The apparatus as defined in claim 1, wherein said substantially constant incremental angle is somewhat less than the field of view angle of the camera, so as to cause overlap at the edges of adjacent images.

7. An apparatus for automatically causing a camera to capture a multiplicity of images as it is rotated through a horizontal angle, comprising:
reference image portion pixel data storage, refreshed each time an image is captured, wherein said reference image portion is substantially a vertical strip at one edge of the image;
sampled image portion pixel data storage, refreshed a multiplicity of times between subsequent image captures, wherein said sampled image portion is substantially a vertical strip positioned at the opposite edge of the image compared to said reference image portion, and has a width and height substantially the same as said reference image portion;
correlation circuit comparing said reference image portion pixel data and said sampled image portion pixel data, so as to identify a peak in correlation signifying the portion of scene represented by said reference image portion is now substantially in the position of said sampled image portion at substantially the opposite side of the camera field of view;
image capture command generator responsive to said peak in correlation.

8. The apparatus of claim 7 wherein the reference and sampled image portions are substantially horizontal, causing the camera to capture a multiplicity of images as it is rotated through a vertical angle.

9. A method for automatically causing a camera to capture a multiplicity of images as it is rotated through an angle, comprising:
electronically sensing the pointing angle of the camera and creating a signal representative of the current pointing angle;
storing said current pointing angle each time the camera captures an image;
adding a substantially constant incremental angle to the most recent stored pointing angle, providing as an output the sum of said most recent stored pointing angle and said incremental angle;
comparing said current pointing angle with said most recent stored pointing angle, thereby generating an image capture command when said current pointing angle and said stored pointing angle are substantially equal.

10. A method for automatically causing a camera to capture a multiplicity of images as it is rotated through a horizontal angle, comprising:
storing, each time an image is captured substantially every H degrees, pixel data of a reference image portion, wherein said reference image portion is substantially a vertical strip at one edge of the image;
storing, every H/M degrees of camera rotation, pixel data of a sampled image portion, wherein said sampled image portion is substantially a vertical strip positioned at the opposite edge of the image compared to said first image portion, and has a width and height substantially the same as said reference image portion;
comparing each subsequent sampled image portion pixel data with said reference image portion pixel data, so as to generate a measure of correlation between pixel data of said reference image portion and each sampled image portion;
comparing said measure of correlation from sampled image portion k with sampled image portion k-1, so as to identify that sampled image portion having the highest correlation with the reference image portion;
generating an image capture command at the time of said peak in correlation, thus storing a new reference image portion;
repeating the above process to capture subsequent images.
